(19) United States
(12) Patent Application Publication
(10) Pub. No.: US 2026/0048820 A1
(43) Pub. Date: Feb. 19, 2026

(54) Hands-Free Circular Flotation Device

(71) Applicant: Bernice M. Champagne, Houston, TX (US)

(72) Inventor: Bernice M. Champagne, Houston, TX (US)

(21) Appl. No.: 19/047,705

(22) Filed: Feb. 7, 2025

Related U.S. Application Data
(60) Provisional application No. 63/683,558, filed on Aug. 15, 2024.

(51) Int. Cl. B63B 34/50; B29C 48/00; B29C 48/09; B29K 105/00; B29K 105/04; B29L 31/52; B63B 5/24

(52) U.S. Cl. CPC B63B 34/50; B29C 48/0018; B29C 48/0021; B29C 48/09; B63B 5/24; B29K 2105/0044; B29K 2105/04; B29K 2995/002; B29L 2031/5254

(57) ABSTRACT

The present disclosure is directed towards a hands-free circular flotation device that includes a ring torus shape foam with a cross section of an annulus. Additionally, the ring torus shape foam is configured to fit around a torso of a human body.

### CROSS REFERENCE TO RELATED APPLICATIONS

This application claims priority from and the benefit of U.S. Provisional Application No. 63/683,558, entitled “Hands-Free Noodles are used to keep your head above water during aquatic exercise, rehabilitation, swimming, floating, and playing. ”, filed on Aug. 15, 2024, which is hereby incorporated by reference in its entirety.

### TECHNICAL FIELD

The present disclosure relates generally to the field of flotation devices for use in water activities. More specifically, embodiments of the present disclosure relate to methods of manufacturing and using hands-free flotation devices.

### BACKGROUND

The traditional pool noodle has been used by consumers to aid in flotation in pools and other bodies of water. The traditional pool noodle design is a cylindrical hollow that is long and linear in shape. The traditional pool noodle relies on users either sitting on the pool noodle or using their arms to hold onto the pool noodle to maintain flotation. When performing water aerobics or other water exercises, individuals typically desire to have their hands and legs mobile to be able to fully perform these exercises. The current pool noodle's available make it difficult for user's hands and legs to be fully mobile when in the water and performing exercises.

### BRIEF DESCRIPTION

In one aspect, embodiments include a hands-free circular flotation device that includes a ring torus shape foam with a cross section of an annulus. Additionally, the ring torus shape foam is configured to fit around a torso of a human body.

In another aspect, embodiments include a method of manufacturing a hands-free circular flotation device that includes inserting a foam material into an extrusion press. Further, the method includes heating the foam material in the extrusion press and pressing the foam through a circular die via an extruder. Additionally, the method includes removing the foam from the extrusion press, wherein the foam is a cylindrical hollow shape, and joining the two ends of the cylindrical hollow to form a donut shaped ring.

In yet another aspect, embodiments include a hands-free circular flotation device includes a ring torus shape foam with a cross section of an annulus, one or more ridges along the outer surface area, and the ring torus shaped foam is configured to fit around a torso of a human body.

### DRAWINGS

These and other features, aspects, and advantages of the present disclosure will be better understood when the following detailed description is read with reference to the accompanying drawings in which like characters represent like parts throughout the drawings, where:

FIG. 1 is a schematic diagram of a hands-free circular flotation device;

FIG. 2 is a drawing of a user using the hands-free circular flotation device;

FIG. 3 is a diagram of multiple hands-free flotation circular devices of multiple diameter sizes; and

FIG. 4 is a method of manufacturing of the hands-free circular flotation device.

### DETAILED DESCRIPTION

The embodiments disclosed herein are generally related to hands-free circular flotation devices and manufacturing of these devices. The hands-free circular flotation device aids in mobility during pool aerobic workouts and/or other suitable water uses allowing users mobility of arms and legs in water activities. For example, the hands-free circular flotation device is generally a donut shape (ring torus shape) formed from suitable foam with a cylindrical hollow running through the center of the foam material. The donut shape allows the user to insert the hands-free circular flotation device around the torso region of the user of the device. This allows the user to have their hands and legs fully mobile during pool exercises. The user of the hands-free circular flotation device may use the device to aid in balance during a variety of water activities. The user may use the hands-free circular flotation device in a horizontal or vertical positioning of the user's body. The hands-free circular flotation device allows the user to have free mobility of their arms and legs during different aerobic exercises, swimming strokes, or any other suitable water activity use.

Further, the diameter of the hands-free circular flotation device can be of any suitable diameter to fit around the torso region (e.g., the waist) of an adult and/or child. The hands-free circular flotation device can be manufactured using extrusion manufacturing methods and joined together via any suitable adhesive and/or manufacturing method. The material of the hands-free circular flotation device may include a polyethylene foam, ethylene vinyl acetate foam, or any other suitable flexible and buoyant material.

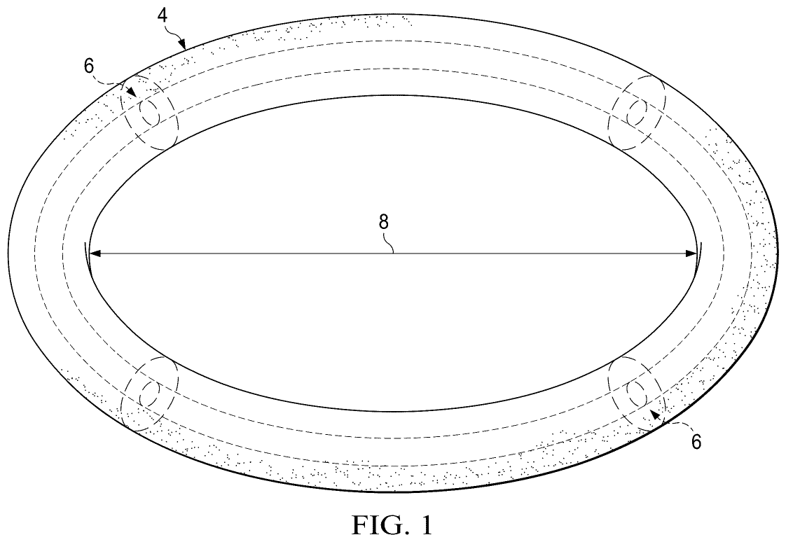

For example, FIG. 1 is a schematic diagram of the hands-free circular flotation device 4. The hands-free circular flotation device 4 may be composed of polyethylene foam, ethylene vinyl acetate foam, or any other suitable flexible and buoyant material. The hands-free circular flotation device 4 is formed in a donut shape with a circular hollow (annular cross section) 6 present through the entire hands-free circular flotation device 4 to enable adequate flotation of the device. The diameter 8 of the hands-free circular flotation device 4 center region can be any suitable diameter to fit the waist of an adult and/or child. For example, the diameter 8 may be any suitable size to fit around the waist of an adult and/or child user to enable flotation. In some embodiments, the hands-free circular flotation device 4 may include a donut shaped foam that is solid foam, and does not include an internal cylindrical hollow, based on the desired buoyancy of the hands-free circular flotation device.

The color of the polyethylene foam, ethylene vinyl acetate foam, or any other suitable flexible and buoyant material used to form the hands-free circular flotation device 4 may be any suitable color, pattern, or design. Additionally, the hands-free circular flotation device 4 may include one or more concave and/or textured sections on one or more portions along the surface area of the hands-free circular flotation device 4. For example, the hands-free circular flotation device 4 may include two or more half-moon concave shaped ridges placed equal distance along the periphery of the device. This may allow the user 10 to rest a portion of the user's 10 arms along the surface area of the hands-free circular flotation device 4.

The hands-free circular flotation device 4 may be manufactured using an extrusion method, or any other suitable manufacturing method. For example, the hands-free circular flotation device may be manufactured in a linear form of a cylindrical hollow and secured into a donut form using any suitable adhesive type (e.g., construction adhesive, all-purpose glue, contact adhesive, spray adhesive). Additionally, the hands-free flotation circular device 4 may be manufactured in a donut form and may be manufactured as an entire donut piece with a cylindrical hollow cross section. Additionally, the hands-free circular flotation device 4 may include an ultraviolet (UV) stabilizer that is added to the polyethylene foam, ethylene vinyl acetate foam, or any other suitable flexible and buoyant material to aid in preventing damage to the polymer that is used to form the hands-free circular flotation device 4 during use in outdoor water activities. As discussed below, a user may position the hands-free circular flotation device 4 around the torso of the user.

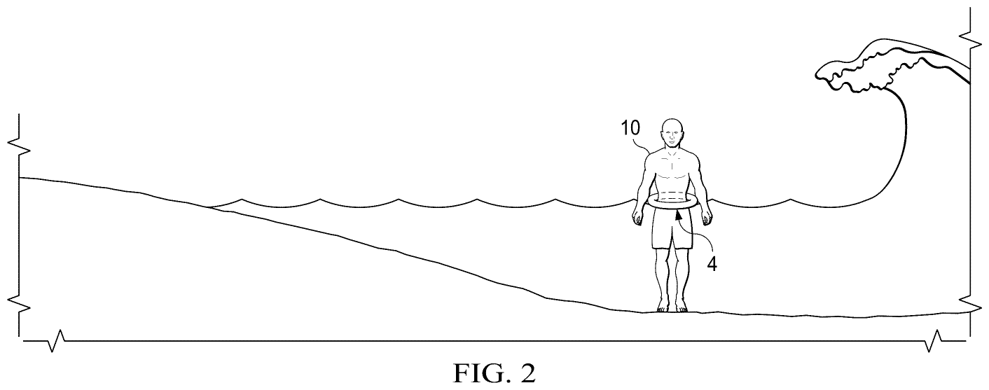

For example, FIG. 2 is a drawing of a user 10 using the hands-free circular flotation device 4. For example, the user 10 of the hands-free circular flotation device 4 may elevate their hands and place the of the hands-free circular flotation device 4 around the user's 10 torso, neck, or any other suitable portion of the body to aid in flotation. This allows the user 10 to have full mobility of their arms and leg to move about in a body of water (e.g., pool, lake) and be able to have freedom of movement for a variety of water activities and exercises. The hands-free circular flotation device 4 allows the user 10 to practice arm motions, leg motions, or any other exercise motion in the water while being aided in flotation by the device.

The hands-free circular flotation device 4 can aid in the user 10 learning different swimming strokes or technique in deep or shallow water, while allowing the user 10 to float or be aided in flotation in a vertical or horizontal position of the user's 10 body. Further, the hands-free circular flotation device 4 can be used for a variety of flotation uses for the user 10 including learning new swimming strokes and/or different water exercises. Further, the hands free circular flotation device may be in a variety of sizes to fit users 10 of all sizes and ages to assist in flotation during water activities.

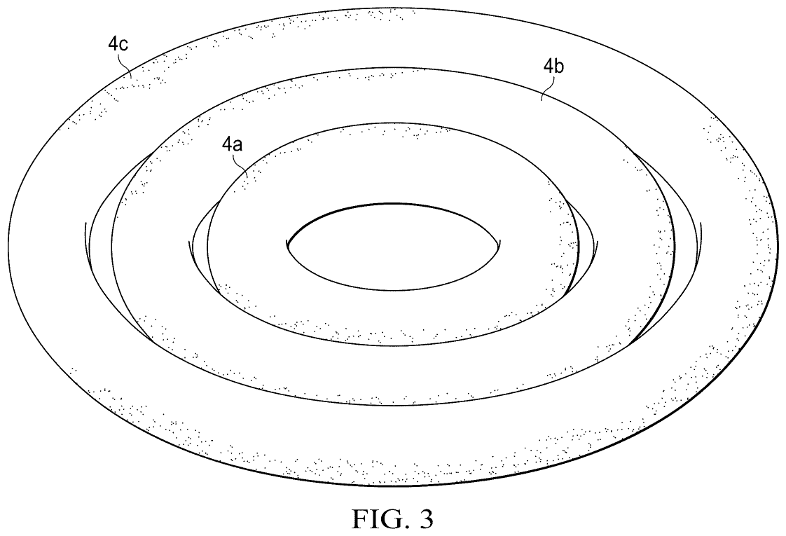

FIG. 3 is a diagram of multiple the hands-free circular flotation devices 4a, 4b, 4c in a variety of diameters 8 to allow for users 10 of different shapes and ages to utilize the device for flotation aid in bodies of waters. The diameters 8 of the hands-free circular flotation device 4 may include any suitable diameter 8 size to fit the user's 10 torso region. For example, the diameter 8 may be anywhere from 10 inches to 50+ inches depending on the size of the user 10. Additionally, the hands-free circular flotation device 4 may be any suitable color and/or pattern to customize the user experience of the device. The diameter 8 of the hands-free circular flotation device may be determined during manufacturing of the device.

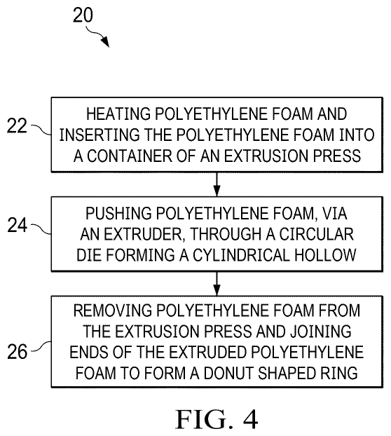

As an example, FIG. 4 includes a method 20 of manufacturing the hands-free circular flotation device 4 using an extrusion based manufacturing process. The method 20, at block 22, includes heating a polyurethane foam or any other suitable material and inserting it into the extrusion press. This may include placing the polyurethane foam (e.g., foam pellets) into a container and/or hopper of the extrusion press that will direct the polyurethane foam or any other suitable material into the extrusion press.

At block 24, an extruder is used to apply pressure and press the melted polyurethane foam through a circular metal die (e.g., circular die with annular cross section) that is used to form a cylindrical hollow. The extruder may utilize a screw device that rotates within a heated barrel to push the polyurethane foam through the circular metal die. The circular die may be designed to any suitable diameter 8 and or hollow 6 size based on dimensions of end user torso size.

At block 26, the polyurethane foam is removed from the extrusion press after being pushed through the die into the desired cylindrical hollow shape. The polyurethane foam may then be cooled and ejected in a linear shape, and then formed into a donut shape by joining of the two cylindrical hollow ends. The ends may be joined using any suitable adhesive and/or securing method to form the hands-free circular flotation device.

1. A hands-free circular flotation device comprising:
a ring torus shape foam with a cross section of an annulus, wherein the ring torus shape foam is configured to fit around a torso of a human body.

2. The hands-free circular flotation device of claim 1, wherein the hands-free circular flotation device comprises a polyethylene foam, an ethylene vinyl acetate foam, or both.

3. The hands-free circular flotation device of claim 1, wherein the hands-free circular flotation device comprises one or more textured regions along a surface area of the hands-free circular flotation device.

4. The hands-free circular flotation device of claim 1, wherein the hands-free circular flotation device comprises one or more concave grooves along an outer surface area of the hands-free circular flotation device.

5. The hands-free circular flotation device of claim 1, wherein the hands-free circular flotation device comprises a plurality of colors covering one or more sections of a surface area of the hands-free circular flotation device.

6. A method of manufacturing a hands-free circular flotation device comprising:
inserting a foam material into an extrusion press;
heating the foam material in the extrusion press;
pressing the foam through a circular die via an extruder; and
removing the foam from the extrusion press, wherein the foam is a cylindrical hollow shape; and
joining the two ends of the cylindrical hollow to form a donut shaped ring.

7. The method of claim 6, wherein the method comprises stretching the foam removed from the extrusion press.

8. The method of claim 7, wherein the hollow cylinder is adhered at both ends to form the donut shape via an adhesive.

9. The method of claim 8, wherein the adhesive comprises a construction adhesive, all-purpose glue, contact adhesive, spray adhesive, or any combination thereof.

10. The method of claim 6, wherein the foam comprises polyethylene foam, ethylene vinyl acetate foam, or both.

11. The method of claim 6, wherein the foam comprises an ultraviolet (UV) stabilizer.

12. The method of claim 6, wherein the circular die comprises a circular donut shape.

13. The method of claim 6, wherein the method comprises removing the foam material in a donut shape with a cross section of an annulus.

14. The method of claim 6, wherein the method comprises cooling the foam removed from the extrusion press.

15. A hands-free circular flotation device comprising:
a ring torus shape foam with a cross section of an annulus, one or more ridges along the outer surface area, and wherein the ring torus shaped foam is configured to fit around a torso of a human body.

16. The hands-free circular flotation device of claim 15, wherein the hands-free circular flotation device comprises a polyethylene foam, an ethylene vinyl acetate foam, or both.

17. The hands-free circular flotation device of claim 15, wherein the hands-free circular flotation device is manufactured using an extrusion process.

18. The hands-free circular flotation device of claim 15, wherein the hands-free circular flotation device comprises one or more textured regions along a surface area of the hands-free circular flotation device.

19. The hands-free circular flotation device of claim 15, wherein the hands-free circular flotation device comprises one or more concave grooves along a surface area of the hands-free circular flotation device.

20. The hands-free circular flotation device of claim 15, wherein the hands-free circular flotation device comprises a plurality of colors covering one or more sections of a surface area of the hands-free circular flotation device.
